(19) United States
(12) Patent Application Publication
(10) Pub. No.: US 2013/0037114 A1
(43) Pub. Date: Feb. 14, 2013

(54) METHODS AND SYSTEMS FOR EMERGENCY WATER STORAGE

(71) Applicant: Atul Sudhalkar, Sunnyvale, CA (US)

(72) Inventor: Atul Sudhalkar, Sunnyvale, CA (US)

(21) Appl. No.: 13/278,345

(22) Filed: Oct. 21, 2011

Related U.S. Application Data
(60) Provisional application No. 61/523,139, filed on Aug. 12, 2011.

(51) Int. Cl. F15D 1/00

(52) U.S. Cl. 137/1; 137/596.12

(57) ABSTRACT

A potable water storage system includes a plurality of water storage containers that are connected to a water inlet. Water flows through the water storage container to water outlets that provides water to the equipment and fixtures of the building. Routine consumption of water by systems and occupants in the building continually refreshes water in the storage containers, without requiring additional energy input or effort in routine operation. The system also includes a bypass pipe that connects the water inlet to the water outlet and bypasses the plurality of water storage containers. Valves are also coupled to the water storage system. In the event of an emergency where potable water is not available, the valves can be closed to isolate the potable water in the water storage containers. The water storage containers can provide emergency potable water to the people in the building and can be expanded or reconfigured.

### CROSS REFERENCE TO RELATED APPLICATIONS

This application also claims priority to U.S. Provisional Patent Application No. 61/523,139, “METHODS AND SYSTEMS FOR EMERGENCY WATER STORAGE” filed Aug. 12, 2011. The contents of U.S. Patent Application No. 61/523,139 are hereby incorporated by reference.

### BACKGROUND

As part of emergency preparations, most families should store at least a week's supply of clean water. At the recommended absolute minimum of a gallon per day per person, this translates into between 20 and 50 gallons for typical families. A problem with stored water is that it deteriorates in quality over time, and the most convenient form of stored water in plastic or glass bottles is of uncertain quality. Other types of non-sealed water storage can also be problematic as the water can be exposed to bacteria. Boiling, chemically treating or filtering stored water adds a level of complexity best not undertaken during emergencies.

The US Federal Emergency Management Agency (FEMA) recommends that families plan for emergency water supplies of one gallon per day for each family member for drinking alone, and the US Homeland Security Agency recommends that families store at least a two week supply of water. More practically, washing, spillage, cleaning of injuries, etc. can increase this recommended volume of water to a couple of gallons available per family member per day, which can require an emergency water storage supply of over 100 gallons for a family of four for two weeks. While this may seem excessive, recent disasters suggest that it would be wise to have enough water available for at least a week—in the US, government relief usually reaches disaster victims within a day or two, but that varies with the scale of the disaster and how well-anticipated it was. Other regions, more remote or more sparsely-populated, might well see slower response times for organized relief, and even in the US slow government relief is not unheard-of, to say the least.

Many families address this need for an emergency water supply by buying bottled water and storing it in car trunks and garages. This is an imperfect solution on many levels because chemicals from plastic bottles can leach into the bottled water and water left stagnant for a length of time can breed microbes. This can occur even in allegedly sterile bottled water in sealed containers. And as the Natural Resources Defense Council has documented, reliance on bottled water is more faith- than fact-based. In fact, the US Environmental Protection Agency (EPA) regulates tap water quality far more stringently than the FDA regulates bottled water supplies!

FEMA recommends that stored water of uncertain quality be boiled, chemically treated or filtered to render it safe to drink. But to boil many gallons of water would tax any family struggling in the face of an emergency. First of all, in an emergency electric or natural gas supplies are surely even more uncertain than the clean water supply. Secondly, elaborate processing of water supplies is unlikely to be convenient after an emergency.

Families, apartment dwellers, schools, governments and businesses who wish to plan for emergencies have an ever-present problem. Disasters natural and man-made all make it prudent to have the means to survive for up to a week, in which time it might be reasonable to assume outside relief would arrive. Recent world disasters including hurricane Katrina in the United States, the 2009 Haiti earthquake, the 2011 earthquake, tsunami, and nuclear meltdown in Japan and the earthquake and flooding in Pakistan all show that having such a survival buffer goes beyond mere prudence. All too often, survival supplies are a necessity.

Many families provision themselves well against hunger, but not so well against thirst. The roots of this situation lie in fundamental biology: water is the basis for all metabolism in earthly life, which makes survival planning doubly difficult. Water is needed not just to drink, but to cook and clean as well. Thus, water is needed in greater quantities than we need food for survival. At the same time, all earthly life finds potable water very convivial, which is why water left in storage for months grows many types of undesirable microbes which would create health problems if this contaminated water is drunk.

Dehydration can be used to preserve food. However, dehydration can also kill humans very quickly. In flooded disaster areas, people are frequently advised to drink water even if it is not clean.

Since dehydration will kill humans faster than most water-borne diseases will, humans who drink contaminated water may survive a few additional days which might be enough time to be rescued and receive medication to counteract the effects of the contaminated water. Neither rescue nor medication will benefit a person who has already died from dehydration.

The prudent consumer thus faces two related challenges in preparing for emergencies. First, readily-available bottled water is of uncertain quality, especially when inexpensive. Second, water quality deteriorates over time which requires replacing bottled water with some frequency. What is needed is an emergency water storage system that can provide the necessary volume of water in the event of an emergency, at a quality level that is higher than the FDA requirements.

### SUMMARY OF THE INVENTION

The present invention is directed towards an apparatus and system for providing emergency storage of water that can be used in the event of an emergency when the normal water supply is unavailable. The apparatus and system can be coupled directly to municipal water sources, such as plumbing systems used to provide drinking water in the vast majority of homes, apartments, offices and other workplaces. The invention can be installed in line with the water supply to such facilities, and routine daily consumption continually refreshes the stored water. Since the water is continuously being refreshed with normal consumption, the problem of deteriorating water quality is thus eliminated, and no active maintenance is needed to refresh the stored water.

The inventive system may provide bottles of fresh water that can be accessed by simply closing two valves and removing the water bottle from the storage system. The bottles can include special internal components that prevent water from being trapped in stagnant pockets, or the formation of eddy currents or turbulence in flowing water. For example, in an embodiment, the bottle may include a helical coil or coils of pipe that are coupled to an inlet and outlet. The water will flow through the pipe and no water can be stagnant within the bottle. In another, the bottle may include funnels or tapered structures that divert water smoothly from the inlet to the outlet while avoiding stagnant water areas.

The inventive system can be modular. For example, the water storage system may include multiple water storage containers that are coupled to modular towers that can be coupled together to form a system having a larger water storage capacity. Each of the towers may be isolated and the valves can be closed so that the individual water storage containers can be easily removed from the system. In an embodiment, the water storage system can utilize pressurized air to drive the stored water through the plumbing system of the building and act as a backup water supply.

The inventive water storage system can be scalable as well. In a large embodiment, the system can include a water tank mounted to the top of a building. When water is needed, a gravitational force of the water can provide water pressure to the plumbing of the building. In a consumer embodiment, the water storage system can be installed under a sink and the water can be refreshed every time the faucet is used.

### BRIEF DESCRIPTION OF THE DRAWINGS

FIG. 1 illustrates an embodiment of the water storage system;

FIGS. 2-3 illustrate an embodiment of the water storage system having a single flow control valve;

FIGS. 4-5 illustrate the use of three-way valves in bypassing and isolating a tower module

FIG. 6 illustrates an embodiment of the water storage system having a plurality of water storage container mounted in tower modules;

FIG. 7 illustrates an embodiment of a tower module;

FIG. 8 illustrates an embodiment of a water storage container;

FIG. 9 illustrates an embodiment of a water storage container on a stand;

FIG. 10 illustrates a water flow pattern within a water storage container;

FIG. 11 illustrates an embodiment of a water storage container having a helical water storage pipe;

FIG. 12 illustrates an embodiment of a water storage container having a rectangular cross section water storage pipe in a helical configuration;

FIG. 13 illustrates an embodiment of a water storage container having a helical water storage pipe with an inlet adjacent to an outlet;

FIG. 14 illustrates a water flow pattern through a water storage container having a serpentine structure;

FIG. 15 illustrates a water flow pattern through a water storage container having tapered construction;

FIG. 16 illustrates embodiments of a roof top water storage system;

FIG. 17 illustrates embodiments of an under counter water storage system;

FIG. 18 illustrates a flow control system for maintaining the required water pressure to the facility that the water storage system is coupled to; and

FIG. 19 illustrates an embodiment of the water storage container.

### DETAILED DESCRIPTION

The present invention is directed towards a water storage system that is capable of storing many gallons of water in portable bottles or fixed tanks that can be accessed in the event of an emergency. The inventive water storage system can be used with houses, offices, schools, apartment dwellings, government facilities, etc., although for convenience we may refer to the facility as a household. As will be fully described shortly, the key innovations include methods and systems which keep the stored water supply fresh without wasting any water, without using any additional energy input, or requiring further attention from the occupants of the household.

Many household plumbing devices and appliances rely on a certain amount of water pressure in order to function properly. Examples include lawn sprinklers, certain water heaters, showers on higher floors, etc. For the present invention to work without reducing water pressure to these water powered devices, it is critical that there should be no significant loss of pressure across it. As will be seen in the descriptions of the embodiments below, the present water storage system should be carefully designed to ensure that water flowing through the system never encounters any substantial flow restrictions that can cause water pressure losses. Water flow restrictions of the present invention can include reduced cross-section, sharp bends in any section of the piping, or couplings and valves which have such restrictions or sharp bends.

The water storage system is placed in-line between the municipal water source and daily household, school or office consumption. The water storage system is optimized to ensure streamlined water flow throughout, with no stagnant water to cause quality deterioration or kinks, flow restrictions or turbulent flow to cause a pressure drop. Once the water storage system is installed and filled with water, routine consumption of water for such activities as: washing, drinking, bathing, lawn sprinklers, etc. will continually refresh the stored water. This delivers an ever-renewed, always-available water storage system for emergencies. The inventive system is also scalable in every household, school, office or other structure to match the needs of the inhabitants.

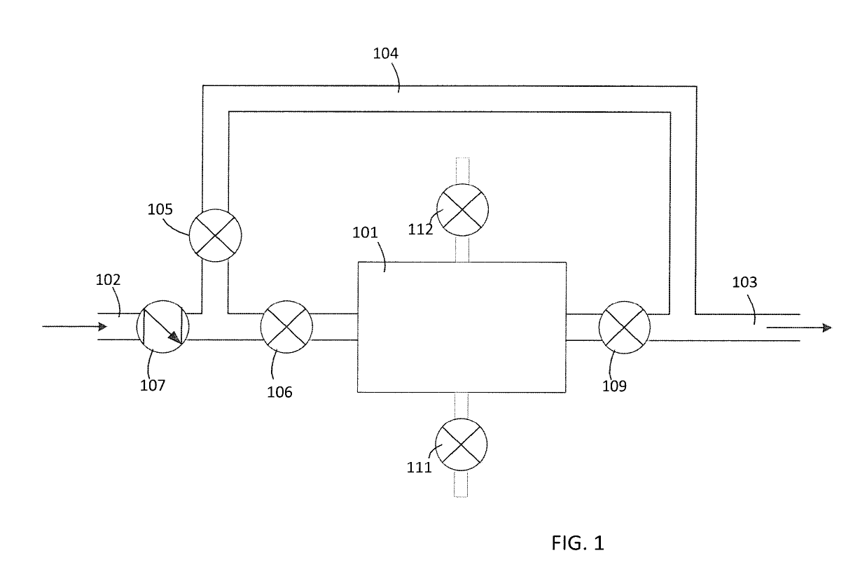

The present invention can be implemented in many different embodiments, described below. Each embodiment can include water storage tanks that are connected in-line between the water supply at the intake end, and the facility plumbing at the outlet. In different embodiments, the water supply can be a municipal water supply at the intake end, and the facility can be a household, apartment, office building, school, etc. With reference to FIG. 1, a water storage container 101 is installed between a water supply 102, such as a municipal water supply and the facility's plumbing 103 on the right. In normal operation, the water storage valve 106 is at least partially open and the valve 105 can be partially open or closed. The water storage container 101 is filled with water and the water in the container 101 is refreshed as water is needed by the facility's plumbing 103. Thus, fresh water is constantly being supplied to the water storage container 101.

When the water storage container 101 is not in refresh operation the inventive system can bypass water around the container 101 via the bypass pipeline 104, by closing the water storage container valves 106, 109 and opening the bypass valve 105. For example, it may be desirable or necessary to bypass water around the container 101 for maintenance or cleaning. Although the water storage container valve 106 and the bypass valve 105 are shown as two separate valves, in an embodiment, these valves can be combined into a single three way valve that allows water to flow into the water storage container 101 in a first position or through the bypass pipe in the second position.

In an embodiment, the system may also include a check valve 107 that only allows water to flow into the facility, either through the water storage container 101 or through the bypass 104, and prevents water from draining out of the container 101 due to reverse flow, to ensure that if the municipal supply line breaks or loses pressure, water will remain in the storage container 101. Thus, in an emergency, water stored in the water storage container 101 may not drain out to any breakages in the supply line to the facility. In an embodiment, the storage container 101 is removable from the system and in other embodiments, the storage container may include a valve 111 to allow users to obtain water from the container 101 as necessary. In some embodiments, the storage container includes an air-bleed valve 112 to permit free outflow of water through valve 111 in such cases.

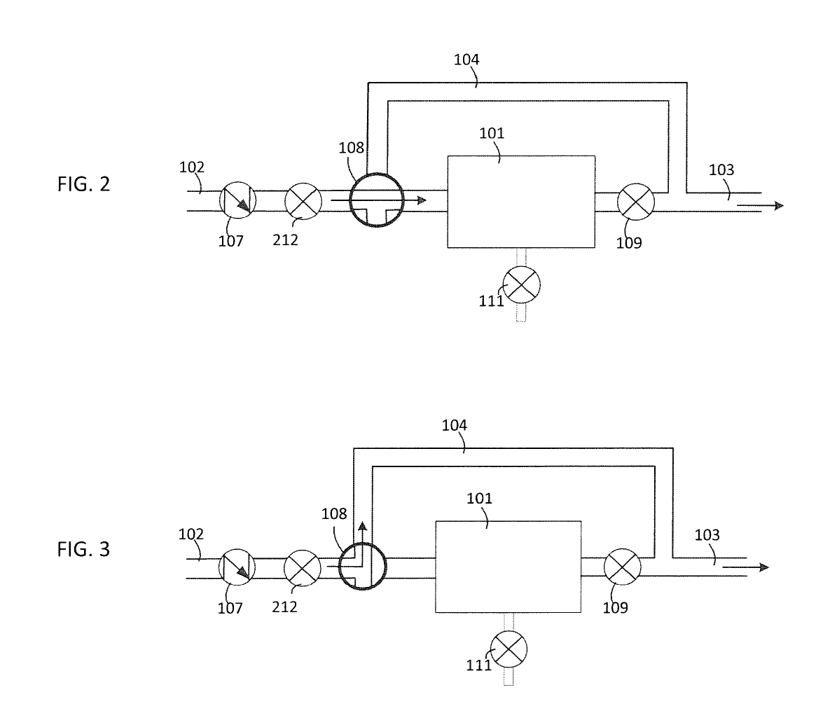

With reference to FIGS. 2 and 3, in order to avoid shutting off all water to the facility, in an embodiment the water valve 106 and the bypass valve 105 can be replaced by a single three way valve 108. As shown in FIG. 2, the three way valve 108 can have a first position that opens a flow path from the water inlet 102 to the water bottles 101 and prevents water from flowing through the bypass pipe 104. With reference to FIG. 3, the three way valve 108 can also have a second position that opens a flow path through the bypass pipe 104 and prevents water from flowing through the water bottles 101. A three way valve can be used in any of the water storage systems described in this patent application as described.

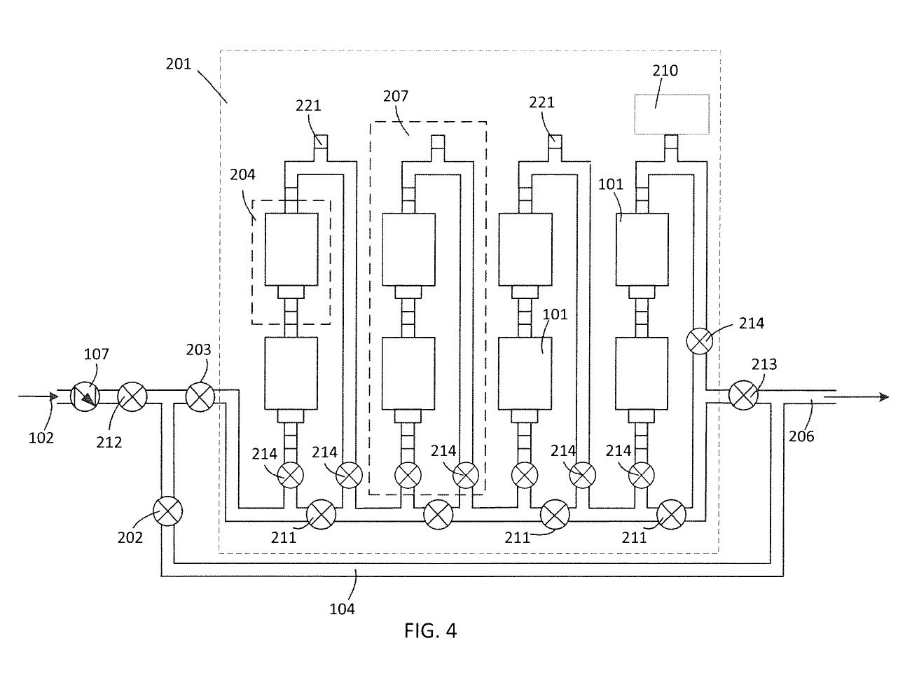

In some embodiments, the water storage system may include a mounting frame to hold the water container. The water containers can normally be in the mounting frame, at or near where the municipal water supply enters the facility to supply the internal plumbing. FIG. 4 illustrates an embodiment of a water storage system 201 for the present invention. In different embodiments, the mounting frame design addresses several functional needs. The bottles 101 can be connected to the facility's water supply 102 and can be configured to draw water from the municipal source through a check valve 107, a water supply valve 212, and the water storage valve 203 to each of the bottles 101 mounted in the frame facility 201. Each of the bottles 101 can be part of a removable bottle assembly 204. The system 201 can also be modular with multiple water storage towers 207 that each include multiple bottles 101, in assemblies 204.

FIG. 4 shows a system having two-bottle towers 207 and a four-tower mounting rack frame 201. Because the water bottles 204 and towers 207 are modular, any particular combination can be used with any mounting rack system 201. In other embodiments, the water storage system can have a different configuration. Any number of storage bottles might be combined to create any tower height and any number of towers can be mounting on any single rack. In an embodiment, the system 201 can add or remove towers 207 from the system 201 without affecting continuity of water supply in the facility. If a tower is removed from service, the corresponding tower bypass valve 211 can be open to allow water to flow to the other towers or to the facility plumbing. When a tower is to be bypassed, it should also be isolated from the water supply to eliminate leaks if the bottles in the isolated tower are to be removed for consumption or maintenance. The tower isolation valves 214 are provided for this purpose: when the valve 211 is opened to bypass a tower, the isolation valves 214 of that tower must be closed.

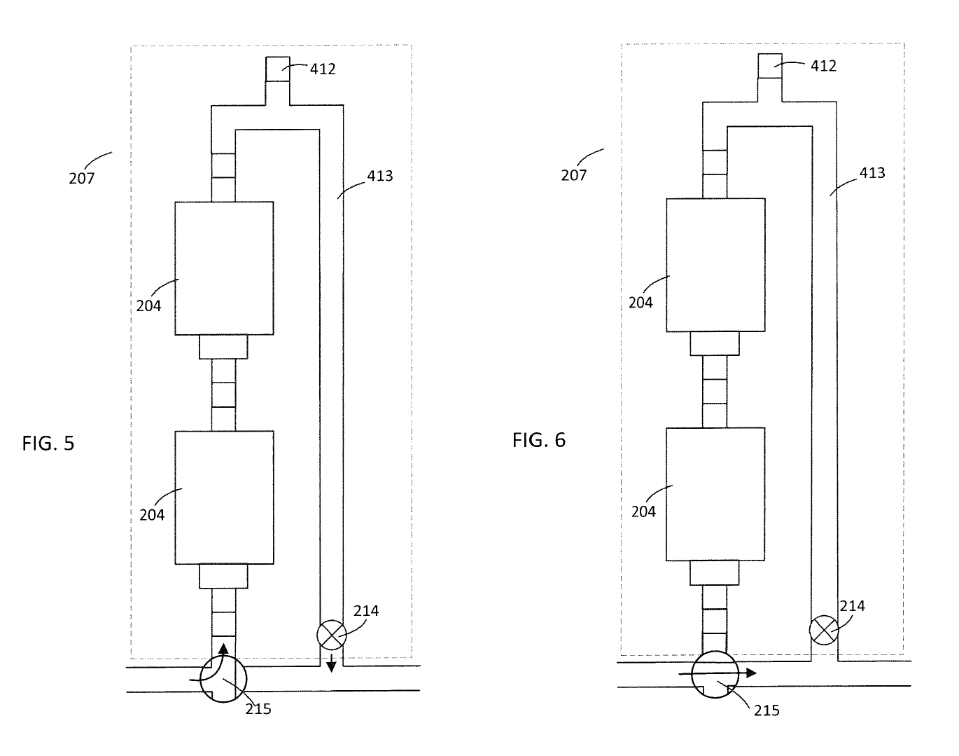

In another embodiment illustrated in FIGS. 5 and 6, the tower bypass valve 211 and tower isolation valve 214 at the tower inlet can be combined into a three-way valve 215, in the manner illustrated previously in FIGS. 2 and 3. In one position of the three-way valve 215 (FIG. 5), the tower is engaged, the tower isolation valve 214 on the tower outlet end is open and the water supply flows through the bottles in the tower before exiting to the next tower or the facility plumbing. In another position of the three-way valve 215 (FIG. 6), water cannot flow into the tower, the tower isolation valve 214 at the tower outlet is closed, thus bypassing and isolating the tower. This renders it safe to remove the bottles in the isolated tower for consumption or maintenance.

Similarly, if a tower is added, it can be coupled to an open space in the system 201 or coupled to the last tower 207 in the system 201. There may only be a brief interruption while the bottles 101 are added or removed. The system 201 can also include a bypass valve 202, so that the supply of water to the facility can bypass all of the bottle assemblies 204 altogether, for instance during maintenance of the frame, its fittings or the bottles. The two valves 202 and 203 can be combined into a single three-way valve to ensure that there is no inadvertent shut-off of water supply to the facility, as described earlier.

The system 201 can be connected at an inlet end to the municipal water supply mains 102 and at the outlet end to the facility plumbing 206. During normal operation, the water bottle valves 203 and 213 can be open, and bypass valve 202 can be closed, so that water from the water inlet 102 passes through the each of the bottles 101 in the frame 201. In an embodiment, the frame 201 system includes a check valve 107 to prevent the back flow of water out of the water bottles 101 in towers 207 and frame 201. If necessary, a bypass valve 202 can be opened to completely bypass the water bottles 101, bottle assemblies 204, towers 207 and the entire frame system 201, enabling a normal supply of water to the facility. The bypass valve 202 can be opened if the invention apparatus is to be cleaned or for other routine maintenance, for instance. In an embodiment, the water valves 203, 213 are operated in conjunction with the bypass valve 202, such that one or the other should always be open. Keeping both open serves no clear purpose, while closing both shuts off all water supplies to the facility.

During emergencies, it is possible that the city supply line might break, and this could cause water pressure to drop. In some situations, this loss of water pressure can result in a reverse flow of water towards the water supply. If the water reverses flow direction, all of the water stored in the storage container can drain out. To prevent this, a back flow check valve 107 can be installed between the water source 102 and the first tower 207 of the mounting frame.

The system 201 may also enable venting of air out of empty bottles 101, as they are mounted, through air vents 221, ensuring that air bubbles do not travel into the facility's plumbing system. Large volumes of air in the plumbing system can be problematic because it disrupts the flow of water to the user or appliances. The flow of air with water can also cause vibration due to gas induced turbulence in the plumbing that can damage the plumbing in some situations. By venting the air as the bottles 204, in towers 207 of system 201 are being filled, only water will be present in the plumbing system, reducing the potential causes of damage to the system.

In an embodiment, each storage bottle assembly 101 can be arranged in stacks or towers 207. Each tower 207 may hold one or more bottles. When two or more bottles are in the tower 207, they can be in series or tandem with the outlet of one bottle assembly 204 connected to the inlet of the next bottle assembly 204 in line, and each tower 207 similarly connected in series or tandem with the next tower 207. In this configuration, the mounting frame is a modular system, expandable by means of having towers 207 of varying height, with a varying number of bottle assemblies 101, which themselves can come in different sizes. Furthermore, the mounting frame 201 can be expanded laterally by having more towers 207 in tandem.

In an embodiment, each tower 207 can be connected in tandem, by having the outlet of the previous in line connected to the inlet of the next tower 207 in line. Each tower 207 can also have a tower bypass valve and pipe 211 connecting the bottom of each tower 207 to the bottom of the next tower 207. The bypass valve 211 can be opened to cause water to bypass the corresponding tower 207, while at the same time closing the tower isolation valves 214, as described earlier. Storage bottle assemblies 204 in the bypassed tower 207 can be removed from the system 201, while the bottles 204 that remain attached to the system 201 continue to hold water and be refreshed as the facility consumes water in its normal way.

During routine operation, the system 201 is configured with a frame supporting one or more towers 207, with one or more bottle assemblies 204 in each tower 207. The supply valve 212, the inlet valve 203 and the choke valve 213 can all be opened, allowing water to freely flow with no restrictions. The bypass valve 202 can be closed to prevent water from flowing around the frame 201. If the bottle assemblies 204 are empty, as may be the case for freshly mounted bottle assemblies 204, the air bleed valves 221 let out the air in the bottle assemblies 204 as water fills from the municipal supply 102.

Once the bottle assemblies 204 are full of water, as the facility consumes water during routine usage for bathrooms, washers, dishwashers, kitchens, refrigerators, lawn sprinklers, etc., water flows through the bottle assemblies 204 and towers 207 of system 201, continually refreshing the water stored in the bottle assemblies 204. Thus, the system is fully operational without any need for moving parts, electrical or other active systems, or any operational attention whatsoever. The system can passively and effectively maintain a fresh supply of stored water.

While emergency water storage needs might be in the range of 1-2 gallons per person per day, normal routine consumption is more likely to be in the range of 10-70 gallons per person per day, so it can reasonably be inferred that the water stored in the bottles of this invention is never more than a few hours old. Studies have been conducted to monitor the daily indoor water consumption per capita. The results of the study indicate that a normal per capita water usage can be about 69.3 gallons per day. Table 1 below indicates the usage of the water and the percentage of water each activity that make up the daily water consumption volume. (Water Research Foundation, Denver Colo. 1999).

TABLE 1

| Use | Gallons per Capita | Percentage of Total Daily Use |
|---|---|---|
| Showers | 11.6 | 16.80% |
| Clothes Washers | 15 | 21.70% |
| Dish Washers | 1 | 1.40% |
| Toilets | 18.5 | 26.70% |
| Baths | 1.2 | 1.70% |
| Leaks | 9.5 | 13.70% |
| Faucets | 10.9 | 15.70% |
| Other Domestic Use | 1.6 | 2.20% |

In general, the volume of water consumed for drinking and other essential water needs is very small in comparison to the total volume of water normally used by each person in a non-emergency situation. If each person consumes an average of about 70 gallons of water per day then a family of 4 people may consume about 280 gallons per day. In an emergency situation, the majority of the normal non-critical water usage will be eliminated. A family may need an emergency water system that stores 50 gallons of water which will provide 2 weeks of drinking water for 4 people. With a water storage system that transmits all used water through the water storage bottles, in a direct flow through system, the water in each of the water storage containers may be refreshed over five times per day. However, as discussed, the system can produce water flow resistance that may cause application problems. The present invention addresses this water flow resistance problem by using components that are designed to minimize the water flow resistance. In particular, various embodiments of the inventive water bottles can include internal structures that achieve the storage and freshness goals described here, without adding any water flow resistance. These bottles will be described later in the application.

With reference to FIG. 2, during emergencies, if the municipal water supply 102 is uninterrupted and uncontaminated, the inventive water storage apparatus continues to function normally. However, if the municipal supply is interrupted or otherwise not available then the supply valve 212 can be closed, sealing off and protecting the fresh stored water from loss or contamination. For example, water from the municipal supply may not be available due to contamination and water can be lost if the water supply pipes upstream of the supply valve 212 are broken and the check valve 107 is not installed. Water mains can and do break during emergencies, and there is danger that water stored in the apparatus described above can get drained out by siphon action. In an embodiment a backflow preventer valve 107 can be mounted between the supply valve 212 and the municipal water supply 102 as a further safeguard against this danger.

In a larger system with reference to FIG. 6, closing the supply valve 212 also prevents contaminated water from the water supply 102 from entering the water storage system 201. With the supply valve 212 closed, water essentially stops being available to the facility, even when the storage bottles are not empty. The closure of the supply valve 212 also stops normal water pressure from the supply 102, so water will not flow into the facility even when taps are opened. Usually this is desirable, since water stored for emergencies probably should not be used in the facility's plumbing. In such situations, homeowners or facility managers can close the choke valve 213, close the bottle shut-off valves and disconnect bottle assemblies 204 from the frame 201 and/or each other. The bottle assemblies 204 can be carried to a dispensing frame for consumption as needed.

In relatively rare circumstances, the municipal supply may be interrupted, but there is no emergency. For example, again referring to FIG. 4, if there is a planned, short-term interruption of water supply for pipeline maintenance, it might be desirable to continue to use the stored water to provide water into the facility's plumbing, drawing down the storage reserve in the bottle assemblies 204. This mode of operation can be achieved by closing the supply valve 212 and the choke valve 213 and opening the bypass valve 202 and the apparatus inlet valve 203. In order to pressurize the water, an air pump 210 which can be located on an upper or top portion of at least one of the towers 207 can be activated, to maintain constant pressure approximately equal to the normal water pressure from the municipal source 102. The air pressure forces water in the storage bottles 101 into the facility's plumbing as it is consumed, just as if the water were being supplied from the municipal source. Of course, this illusion of water continuity from a large water supply only lasts until the storage bottles are drained, unless municipal supply resumes before the bottles are emptied.

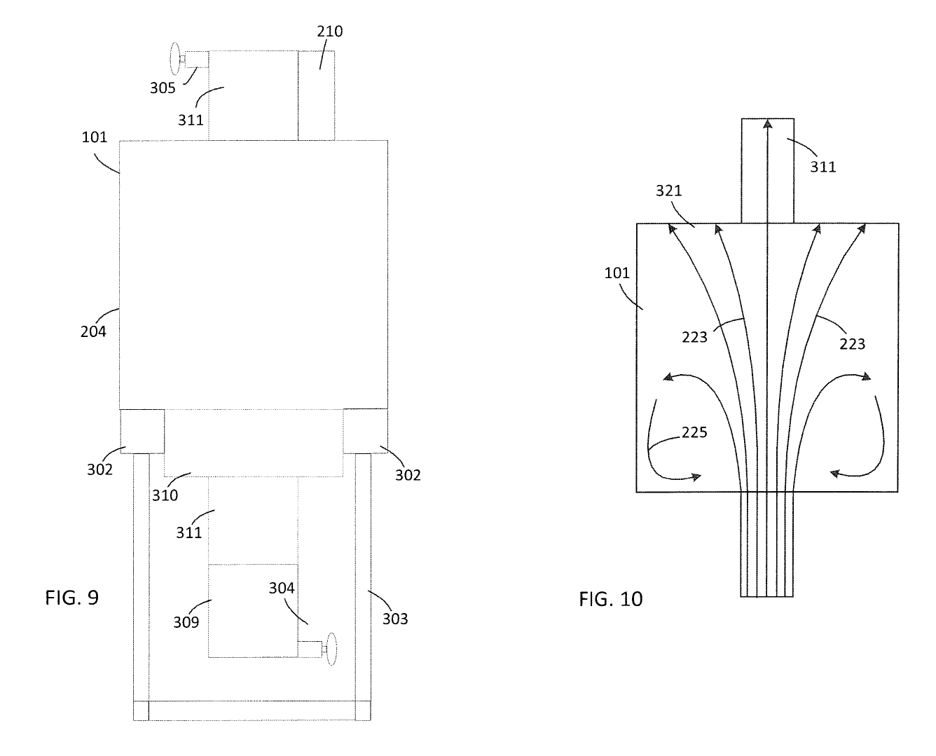

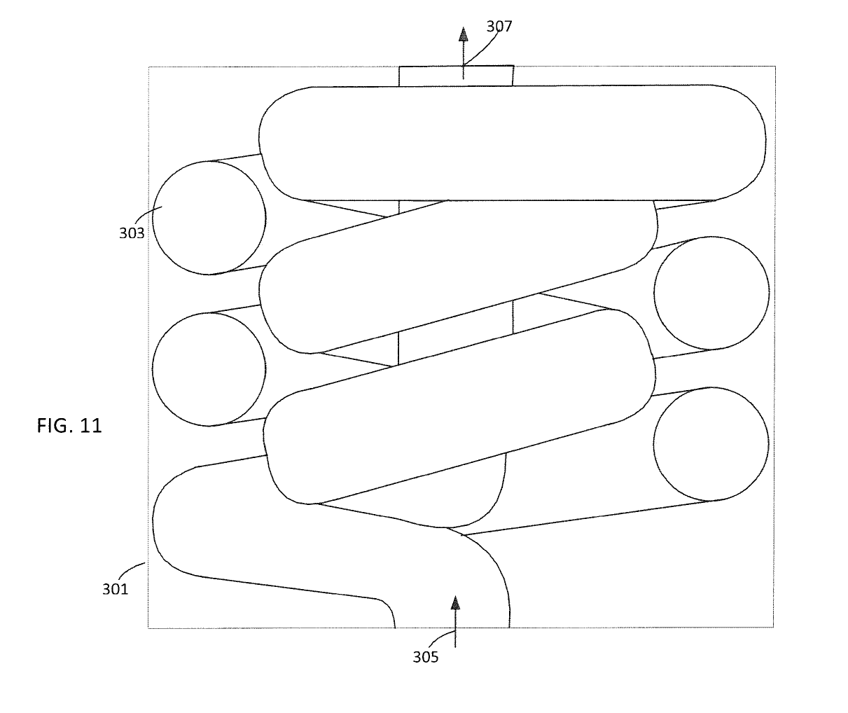

The described air pressure system can provide additional expulsion force to remove all of the water from the water bottles 101 when water is needed. In some embodiments, the water storage bottles do not permit the free flow of water even with taps (tap 111 in FIG. 1) open. This can be due to convoluted water flow paths (e.g., FIG. 11). In these embodiments, the dispensing frame can have an optional hand-operated air pump 210 to force the stored water out, as shown in FIG. 9. By forcing the water to travel through a convoluted pipe in a water storage container, there is no chance of stagnant water in the system because all water in the pipe will travel through the storage bottle.

To ensure continuity of water supply during emergencies, it may be better not to rely on the operation of an electric air compressor. Alternately, the air pump 210 can be replaced with an air compressor and a compressed air tank. The air compressor can maintain the air pressure within the air tank during normal operation. If power is cut off, the stored air pressure can still be used to pressurize the water in the bottles 101 and provide simulated water pressure to the system 201. In contrast to water which is essentially an incompressible liquid, the air is a compressible gas that can expand to drive the water from the storage bottles 101. The compressed air can be stored in an air tank. As the air expands, the pressure decreases proportionally based upon the equation:

$$P = \frac{n R T}{V}$$

Where P is absolute pressure of the gas, n is the amount of the gas substance, R is the ideal or universal gas constant equal to the product of Boltzmann's constant and Avogadro's constant. In Si Units, n can be the quantity of gas measured in moles, T in degrees Kelvin and R has a value of 8.314 J/(K mol). Thus, the size of the air tank and the air pressure within can be calculated to match the expanded volume and pressure needs of flushing out the volume of all the bottles 101 and towers 207 of the assembly 201.

During routine maintenance of the assembly 201, cleaning, replacement, etc., it may occasionally be necessary for facility managers, homeowners, plumbers or maintenance crews to remove bottle assemblies 204 from the mounting frame system 201. The apparatus can then be configured for interrupted water service as explained above by closing the apparatus inlet valve 203 and the choke valve 213 and opening the bypass valve 202. Water from the inlet 102 can then bypass the water storage bottle assemblies 204 and be consumed normally while the water storage bottle assemblies 204 are being worked on. This allows the conduct of routine inspection, maintenance and cleaning without spilling or disposing of stored water. Water conservation may be a concern for conscientious consumers and for those living in areas of water scarcity.

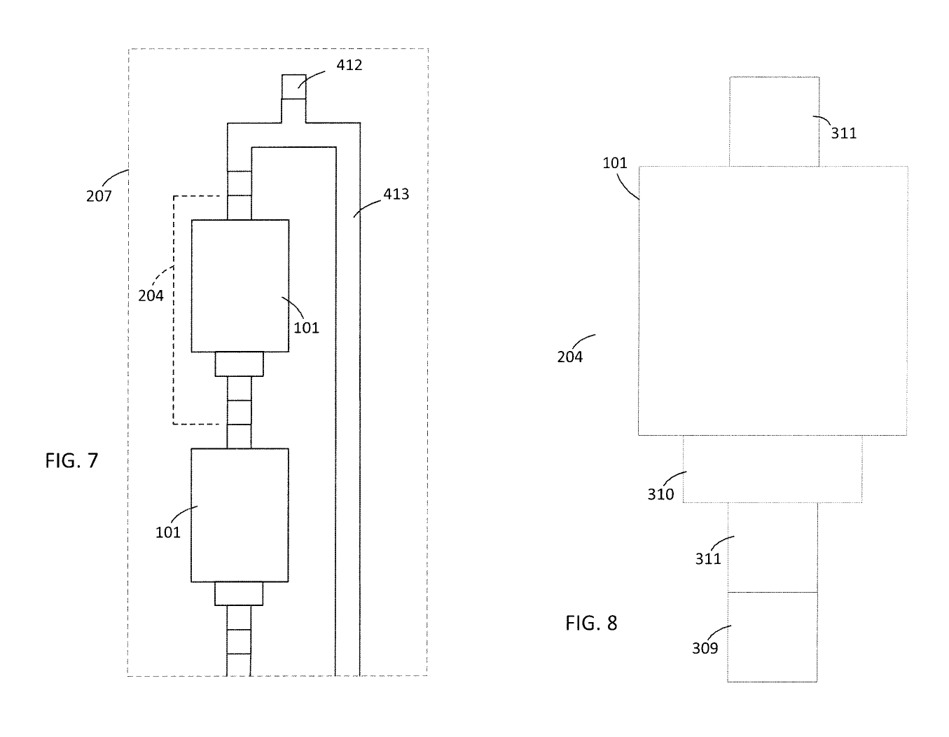

With reference to FIG. 7, an embodiment of a tower assembly 207 is illustrated. The purpose of the tower assembly 207 is to connect two or more water bottle assemblies 204 in series or in tandem, so that the water outlet of one bottle assembly 204 connects to the water inlet of the next bottle assembly 204. To this end, the connector can be a single pipe, ending in a male screw-on end, to be joined to the coupling 309 of the lowermost bottle of the next tower. In an embodiment, an air bleed valve 412 can be mounted at the top of the tower assembly 207. The air bleed valve 412 is useful in removing air from the tower 207. When empty bottle assemblies 204 are mounted in the tower 207, it will initially be full of air which must first be bled off since the bottle assemblies 204 need to be filled with water to avoid sending air on into the household plumbing, which can cause problems in water heaters, ice-makers and similar common devices. The tower 207 can also include a coupling 413 that allows the outlet of the tower 207 to be connected to another tower 207 or to the facility plumbing in a modular manner.

With reference to FIG. 8, an embodiment of the bottle assembly 204 is illustrated. The bottle assembly 204 can include water storage bottle structure 101, a connector 309 that can be a threaded screw-on female connector. The connector 309 serves to connect the bottle structure 101 to either another bottle below the bottle 101 in a tower or to a mounting frame. Connector pipes 311 which provide a water flow path through the bottle assembly 204. In an embodiment, bottle assembly 204 can be set up in a vertical configuration. Thus, by closing the shut off valve 310 mounted below the water bottle 101, the water in the bottle assembly 204 can be removed from the tower assembly 207. The shut off valve 310 must be opened when the bottle structure 101 is mounted in the tower 207 and closed before the bottle structure 101 is dismounted,—for instance, when removing the bottle for consumption in an emergency. Above the storage bottle 101 is another connector pipe 311, the bottle 101 outlet lead, further described in specific embodiments below.

In order to make it easy to move the bottle assemblies 101 around and dispense water to people in different locations during an emergency, bottle assemblies 101 can be sized between about 1 and 5 gallons so they can be easily carried. Each gallon of water weighs about 8.3 pounds, so a 5 gallon bottle will weigh over 40 pounds. For most facilities, the water storage system may require multiple bottle assemblies 101 to provide several days supply of water to people in the building in the event of an emergency. In an embodiment, the emergency water supply system in a mounting frame configuration may provide a convenient method for mounting multiple portable water storage bottles with easy access to users.

The mounting frame of the above embodiment serves to hold the bottles in place, in line with the facility's water supply. In an emergency, with water supply disrupted, inhabitants of the facility would need to disconnect the bottles and remove them from the mounting frame in order to use the stored water. The dispensing frame holds one or more bottles at a time, with attachments to make dispensing easy and to minimize spillage.

FIG. 9 illustrates a dispensing frame design. Key features of the dispenser include a frame 302 to hold and protect the storage tank 101 from accidental damage, a stable base 303 on which to rest the bottle 101, a connector pipe 311 to connect to the bottle 101, a connector 309, a small-diameter tap 304 to dispense water for consumption, and a small-diameter air-inlet valve 305 to permit free flow of stored water when the dispensing tap 305 is open. The valves 304 and 305, allow the stored water to be removed from the bottle 101 while protecting the stored water from contamination by debris dropping from above. In an embodiment, the frame 302 may include wheels that allow the frame to be moved easily.

In an embodiment, it might be desirable to provide a pressure force to the stored water to expel water more forcefully, or expel water from convoluted passage-way designs of some bottle embodiments. In order to pressurize the water, an air pump 210 which can be located on an upper or top portion of the bottle 101 and closing the air-inlet valve 305 to maintain constant pressure approximately equal to the normal water pressure from the municipal source 102. The air pump 210 can be a powered unit, a manual air pump, or any other suitable gas compressor or compressed gas storage unit.

With reference to FIG. 10, a flow path of water through a water storage container 101 is illustrated. As water flows vertically through the water storage container 101, the upper interior surface 321 can create eddy flows 225 and stagnant water. For example, if the water bottle 101 is a cylindrical or box shape, there can be interior surfaces 321 that are substantially perpendicular to the flow of water 223. As water 223 flows into the bottle 101, some of the water 223 can flow directly through the bottle 101 to the outlet 311. However, much of the water 223 can expand radially and then flow into the interior surface 221 which causes the water 223 flow to change direction resulting in flows which can cause pressure drops. The water 223 flow can also cause swirling or eddy currents 225 of the water 223 within the container 101. Thus, while some water will flow directly through the bottle 101 some other water can swirl and remain in the bottle 101 for extended periods of time. In an embodiment, it is possible to have a water storage bottle 101 that has interior features that prevent the water from stagnating. Various other problems can occur with an open volume including generating a resonant frequency causing vibrations, noise and consequent damage to the plumbing.

With reference to FIG. 11, in an embodiment, the water storage bottle 301 can be configured to have an interior piping system 303. In this example, the piping system 303 includes a length of pipe that is wrapped in a helical pattern within the storage bottle 301. Water can enter a bottom inlet 305 and travel through an outer helical piping and then through an inner helical piping. The pipe can then travel axially through the center of the bottle to an outlet 307. The nested, inner helix still leaves about two pipe diameters of room inside, and a straight length of the same pipe can run back through the center line of the device, yielding a bottle design with inlet 305 and outlet 307 on opposite ends. To illustrate scale, we can analyze the dimensions of an embodiment: assuming the pipe bent into a helical shape is of 1.5 inches diameter, an embodiment with a 9 inch helix diameter and a helix height of 1 foot will store about 1.4 gallons of water. The inner helix, of approximately 6 inch helix diameter, will hold about 0.9 gallons, and the pipe running up the central axis of the helix will store about 0.09 gallons, adding up to about 2.5 gallons of water stored in such an embodiment.

The design of this embodiment can include: a pipe 303 twisted into a helical shape, with suitable connectors at the ends 305, 307 to facilitate the use of the invention as a water storage device. The key design feature is that the basic shape is a pipe, so that water flowing through it is never stagnant as long as there is water consumption in the establishment in question. The pipe 303 can be constructed from suitable water-carrying materials such as: copper, steel, PVC, acrylic, etc., depending on the specific application, embodiment, scale, etc. The pipe 303 has an inner diameter, and an outer diameter. The difference between the inner and outer wall diameters gives the wall thickness of the pipe 303. The pipe 303 is twisted into a helical shape, which is characterized by the helical diameter, which is measured as the spread of the central axis of the pipe or tube, as viewed from above along the central axis of the helix. The change in vertical position of the tube as it is twisted around into the helical shape is called the pitch of the helix. The pitch and outer diameter of the pipe 303 combine to determine the total height of the helix and the number of loops.

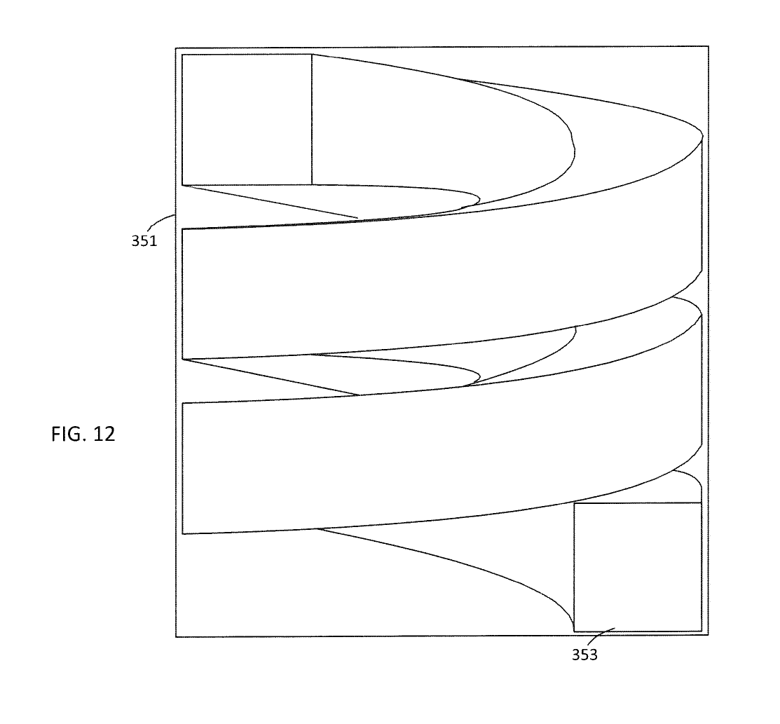

In some embodiments, it is possible to improve the water volume of the piping system by using pipe that has a rectangular cross section. With reference to FIG. 12, in an embodiment, a water storage container 351 can include a piping system 353 that includes a length of pipe that has a rectangular cross section that is in a helical configuration. The described circular or rectangular cross section helical pipe design is scalable to fit various usage scenarios such as under-sink installation, whole-house installation, large-facility installation, etc., for illustrative purposes we can examine a model suitable for household installation. A 1.5 inch inner diameter pipe, twisted into a helix of 9 inches outer diameter will hold a gallon of water in a device under 9 inches tall, which is a very convenient size for a gallon container of water.

The end leads of the tube within the water storage container can be shaped to facilitate connections to mounting frames and dispensing frames. Since mounting and dispensing fixtures are common to all bottle embodiments, these are described separately. The end lead designs vary between some embodiments but are shared by others; these are described as we describe the first embodiment to which they apply, and are referred to from later-described embodiments which also use them.

In an embodiment, the ends of the water containers can be fitted standard ball-and-cock valves, since these ensure a smooth-bore connection to the municipal supply at the intake end, and to the household plumbing at the outlet. This design preserves water pressure across the device, leading to no incremental pressure loss or flow restriction due to the device itself.

This embodiment of the inventive water storage containers is stackable, the details of which are described below. As discussed, there is a high degree of scalability in this design. In an embodiment, the piping used with the water storage container can be 1½ inch diameter pipe, which matches the usual diameter of pipe for most municipal water connections in the United States. But the core concept is scalable to other sizes as well, to better fit local standards, or for more niche uses, as is discussed below.

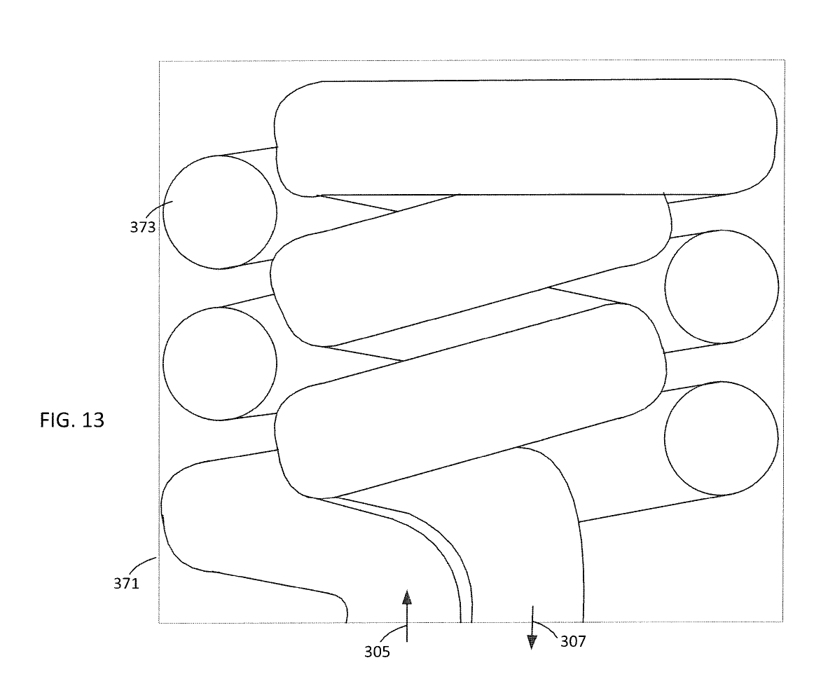

With reference to FIG. 13, in an embodiment the helical bottle 371 can have an outer diameter of about 9 inches and a height of about 9 inches and an internal volume that holds about a gallon of water. The capacity of the bottle 371 can be improved by twisting the same pipe 373 into a 6 inch outer diameter helix, and nesting the smaller helix inside the larger one. The pipe's wall thickness can be about a tenth of an inch, which may alter the dimensions of the water storage container, but only by a small amount given the scale of the overall device. Simple calculations show that this smaller, inside helix would hold about 0.6 gallons for the same “bottle” length. The two nested helices yield a bottle with inlet 305 and outlet 307 adjacent to each other, which can be a desirable feature in some applications. In a bottle 371 having a 9 inch outer diameter and a 9 inch height, the total capacity of the container can be about 1.6 gallons using a 1.5 inch diameter pipe.

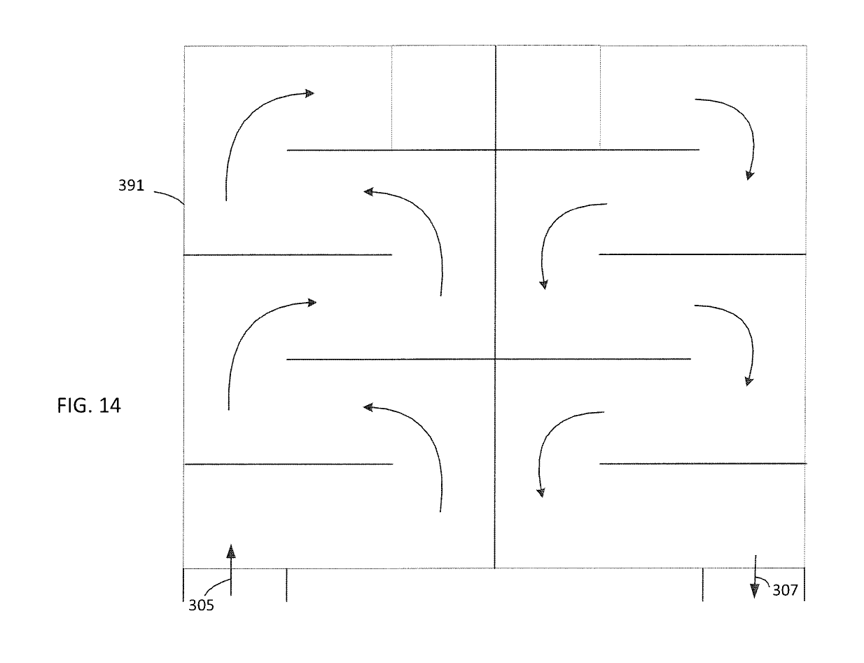

In other embodiments, the flow path through the water storage container can be a flattened serpentine or helical pattern. With reference to FIG. 14, a cross section of a water storage container 391 is illustrated. The water inlet 305 can flow through a serpentine pattern from the bottom of the container 391 to a top surface of the container 391. The flow path can then extend to an adjacent cross section. The outlet return flow path can similarly have a serpentine pattern that leads to the water outlet 307. In other embodiments, if the water flow pattern is helical, the axis of the helix can be bent around into a circle or ellipse, giving the twisted pipe an overall annular shape.

In another embodiment, it may be desirable to have a box shaped water container that will fit within existing fixtures such as sink cabinets and provide more interior volume than a cylindrical structure. The core idea of the helical bottle, described above, can be varied to have an approximately rectangular cross-section. This shape is easier to put on racks or in small enclosed spaces such as under kitchen sinks. In this embodiment, the construction can be similar to the annular bottle embodiment described above, but the annular ring around which a pipe is wrapped is rectangular in shape, giving an overall rectangular shape to the bottle.

An innovation in this invention is ability of the system to provide water storage in-line with a facility's municipal water supply, so that the stored water is continually refreshed by routine consumption within the facility. The most certain way to do so is by avoiding any stagnant pools, hence the helical twisted-pipe design of the embodiments described above. In low-flow scenarios this can be the only way to avoid stagnant pools. But in higher-flow situations there are simpler embodiments possible. The funnel-ended bottle is one option.

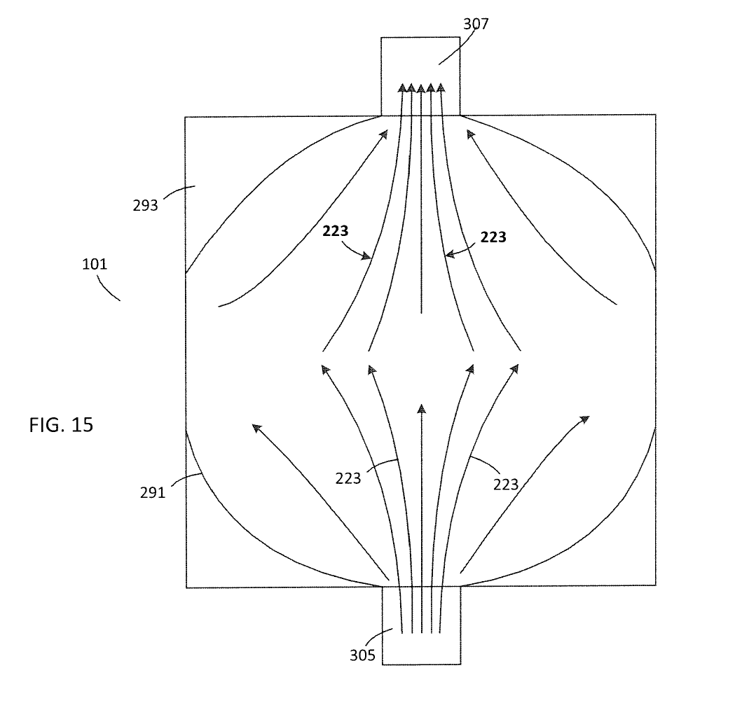

Since the primary functional goal is to avoid stagnant pools and to avoid impediments to water flow, a large-diameter pipe can serve the water-storage goal while providing free flow of water through it. For illustrative purposes, we shall again assume that the larger diameter in question is 9 inches. In an embodiment illustrated in FIG. 15, the water container 101 design provides a gradual transition in cross section from the inlet 305 which can match the diameter of municipal supply pipes of 1 to 1½ inch diameter. The interior of the water container 101 can have tapered portions 291, 293 that allow the water 223 to flow smoothly through the water container 101. The first tapered portion 291 can expand from the inlet pipe diameter to the outer diameter of the water container 101 and the second tapered portion 293 can taper down from the outer diameter of the water container 101 to the diameter of the outlet pipe 307. The tapered portions 291, 293 cause the water to flow 223 through the water container 101 without any eddy or back currents or stagnant water, thus eliminating turbulence, pressure drops and stagnant water. In other embodiments, the tapered portions 291, 293 can be different shapes such as conical or convex conical or a combination of different surface shapes. Again, the design of the water storage system emphasizes ease of connection, modularity of storage, good flow characteristics to minimize pressure losses and stagnant water, and easy portability when consuming the water in emergencies. For illustrative purposes, we assume a bottle diameter of 9 inches, and a bottle height of 9 inches. Allowing for the tapered funnel design of the top and bottom of the bottle, this yields a storage capacity of about 2 gallons of water per bottle.

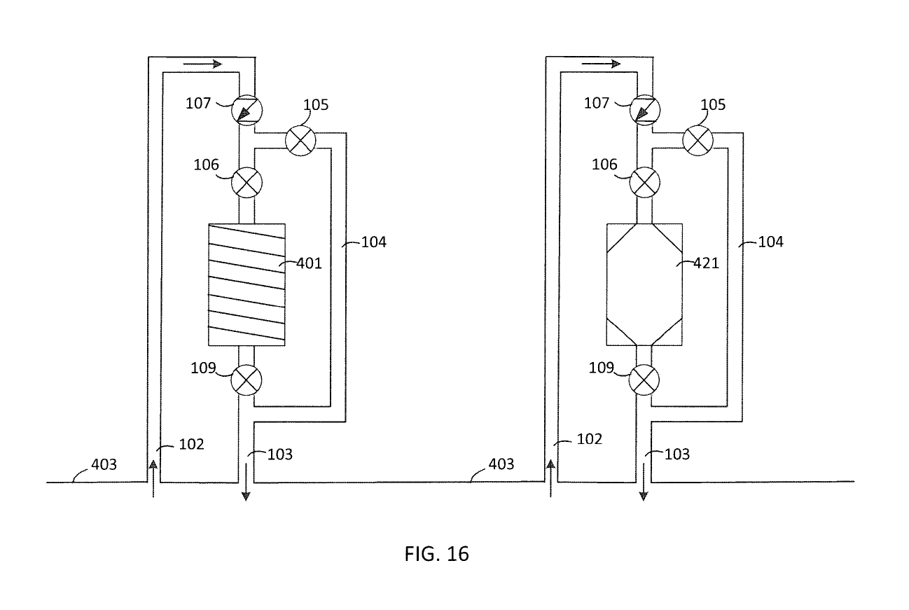

In other embodiments, the inventive system can be applied to water storage containers that are substantially larger in volume. For example, with reference to FIG. 16, the water storage tank 401 can be a rooftop 403 mounted tank of helical or other design, similar to the water storage tanks described in FIGS. 11-13. However, the volume of the water storage tank 401 can be substantially larger than the removable containers described above. In an emergency with municipal water supply interrupted, the tank itself provides water to the facility's plumbing fixtures. Hence it may be more appropriate to refer to this water storage structure as a tank rather than a bottle. A primary difference from the above-described embodiments is that the tank 401 is not a portable water container intended to be detached from its mount before dispensing water in an emergency. Rather, the water storage tank 401 always remains connected to the facility's plumbing, and dispenses water in an emergency through the same connection. Because the tank does not move, it can be important to configure the inlet 102 vertically above the water storage tank 401 so that if water is unavailable from the inlet, the water will flow down through the tank 401 by gravity and be able to provide water to the building without the need for pumps or other water pressurization systems.

Conceptually, the tank 401 mounts on rooftop 403 so that water will continue to be available in all the plumbing fixtures in the facility. The rooftop mount is not essential, of course. In this embodiment in particular, an embodiment with the helical twisted-pipe design expands to a larger-diameter pipe, twisted into a larger diameter helix, and with a longer overall length, since it is not intended to be portable. One or more such tanks 401 can be connected together in series or in parallel and still in-line between the municipal water supply and the facility's plumbing. The helical bottle of embodiment 3, as it mounts into the mounting frame of embodiment 1, can also be scaled up to constitute a tower all in itself. In such an embodiment, the storage tank is not intended to be portable, but is expected to be tapped in-place during emergencies.

In an embodiment, a representative set of dimensions for such a single tower helical tank would include an internal water storage tube that has an outer diameter OD of about 3 to 6 inches, helix diameter of about 24-36 inches, and a height of about 6-8 feet. At the low end of the range, each such water storage container may hold approximately 15 gallons of water and at the high end, the water storage container may hold approximately 32 gallons. A family might therefore choose to install two or three or more such tanks to provide a reasonably plentiful supply of water for emergencies.

FIG. 11 illustrates an embodiment of the shape of the internal pipe 301 for the water storage container 301. The bottom end of the helical coil 303 is coupled to the water inlet 305 and the top end of the coil 303 is coupled to the outlet 307 for the storage tank 301. This water flow direction, combined with the air bleed valve 412 shown in FIG. 7, ensures that empty bottles fill up properly when assembled into the system with minimal air bleeding into the facility's plumbing. The rising helical coil, which is vertically oriented, ensures that trapped air is eliminated during normal (non-emergency) operation of the apparatus. It also ensures that during emergency operations, water can be tapped from the bottom of the storage tank 301, and the tank 301 will fully drain, requiring no re-orientation of the tank 301 or assistance from water pumps or air pumps. In embodiments with a single helical coil, the water drains solely by gravity. In embodiments with nested helical coils with both inlet and outlet end leads adjacent to each other (FIG. 13), the end leads can both be tapped one after the other, with an air bleed valve at the other end of the bottle to let in air as water is tapped. In embodiments with nested helical coils with end leads emerging from opposite ends of the bottle (FIG. 11), the bottle can drain fully by a combination of gravity and siphon action. Alternately, for embodiments similar to FIG. 11, the bottle can be partially drained in one orientation, and then flipped over to be drained from the other end lead. In such embodiments a separate air bleed valve may not be necessary.

The water pressure can also be reduced by plumbing that requires moving water vertically. The pressure required to pump water up 1 vertical foot is about 0.43 pounds per square inch (PSI). Thus, the pressure required to move water 100 feet up will be about 43 PSI. Multistory buildings may have to compensate for their height by using pumps and water storage tanks located at one or more elevated heights within the building. Thus, water is first pumped to water storage tanks at elevated heights and then additional pumps may be required to provide water at the required water pressure to the faucets, toilets, water fountains, etc. in the building. In general, tall buildings may face the problem of maintaining water freshness even in routine use, not just for emergency water storage. Some embodiments of the present invention are particularly well-suited even for supporting routine use in large facilities and multistory buildings. It is also possible to mix and match the different water storage systems and water storage containers. For example in an embodiment illustrated in FIG. 16, the roof top water storage tank 421 can include a funnel water storage structure rather the helical pipe container 401.

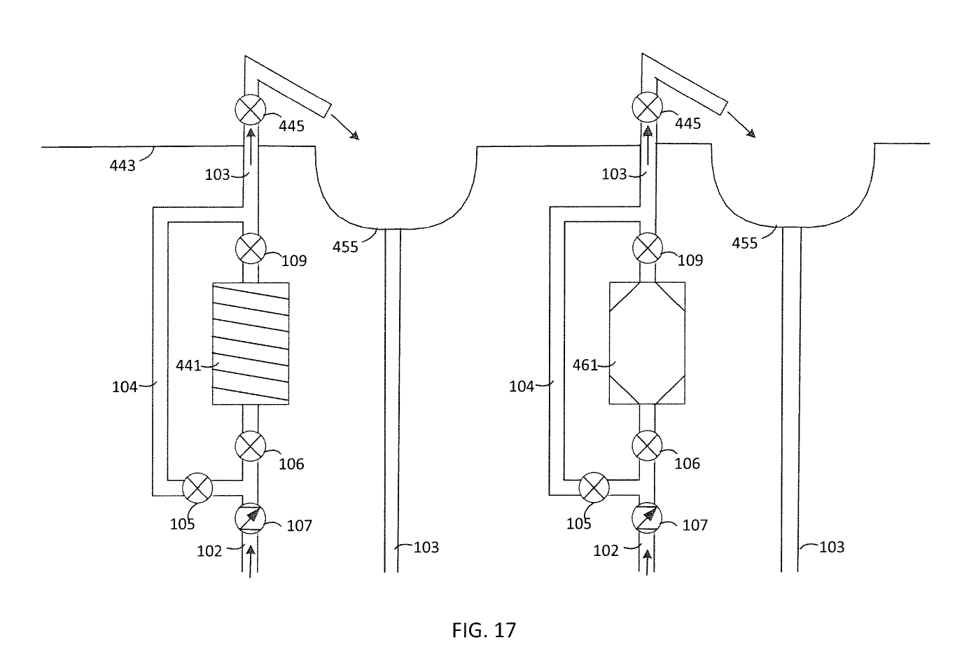

In an embodiment, the inventive water storage system can be retrofitted to work with home applications. For example, referring to FIG. 17, the inventive water storage system may be mounted to a water faucet 445 under a counter 443 and adjacent to a sink 455. In an embodiment, the water storage container 441 can include an internal helical pipe. In another embodiment, the water storage container 461 can include tapered sections that allow water to flow smoothly through the container 461 without dead regions, turbulence or eddy currents that can result in stagnant water and/or pressure loss. When a user turns on the faucets 445 water is consumed and fresh water flows into the water storage container 441, 461.

In some embodiments, it may be more important to maintain the flow of water with minimal flow resistance than refresh the entire storage volume of water five times per day. In an embodiment, the system may include a water flow control valve that can split the flow of water depending upon the water flow demands. High water pressure and water flow rate can be important for providing normal water use function. For example, a shower may require a certain minimum water pressure in order to function properly. However, other water consuming house or office fixtures may not require high pressure or high water flow. For example, when a toilet is flushed, the water in the tank is replenished but the speed to refill the tank is normally not urgent.

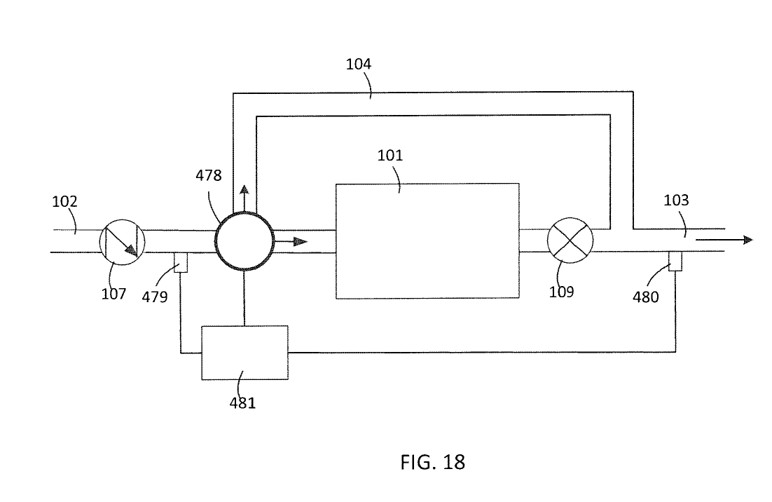

In an embodiment with reference to FIG. 18, the inventive water storage system can alter its flow resistance based upon the detected water pressure drop across the water storage system or a minimum outlet pressure by using a flow control valve. A controller 481 can be coupled to a flow control valve 478 and pressure sensors 479, 480. The flow control valve can direct some of the water through the water storage system and water storage container 101 and the remaining water can be diverted through the bypass pipe 104 which will have less flow resistance. The controller 481 can monitor the pressure across the system with a pair of pressure transducers 479, 480 mounted at the inlet 102 and outlet 103 of the water storage system. Alternatively, the controller 481 can just monitor the outlet pressure through the pressure transducer 480 at the outlet 103.

If the outlet water pressure is high and the difference in water pressure between the inlet and outlet will be very small, the controller 481 can actuate the flow control valve 478 so that most or all of the water can flow through the water storage container 101 so that the stored water is refreshed. However, if the system controller 481 determines that the outlet water pressure is below a minimum required pressure or the pressure drop from the inlet to the outlet is greater than maximum predetermined pressure drop, the controller 481 can alter the flow control valve 478 position to cause more water to flow through the bypass pipe 104. Since the bypass pipe 104 may have less flow resistance than the storage bottles, more water will flow through the system and the outlet pressure can return to the necessary minimum pressure or the pressure across the system can be reduced below the maximum allowed pressure drop.

In some cases alluded to above, the volume of daily, normal or non-emergency water usage far exceeds the emergency requirement. As mentioned before, per capita consumption of water for routine uses in the bathroom, laundry room and kitchens is estimated to average around 70 gallons per day, which far exceeds the emergency recommendation of 1-2 gallons per day. Even totaled over the recommended number of days to provision against emergencies, this still represents a quarter of per capita daily consumption. In many situations, the actual per capita consumption can even be higher—for instance, when factoring in yard usage, swimming pools, car washing, etc. For some consumers, for instance apartment or rental unit dwellers, space availability can be a significant constraint. Renters also cannot easily make major installations or modifications to the building's water supply.

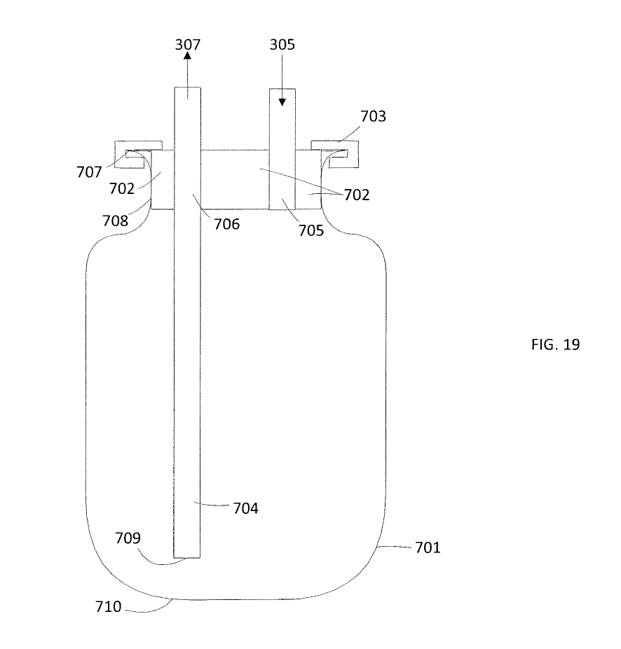

In an embodiment with reference to FIG. 19, the inventive water storage system can more conveniently meet the needs of either of the two groups described in the preceding two paragraphs. In this embodiment, the storage container or bottle 701 is of a size holding between 2-6 gallons of water. The container is similar in shape and dimensions to five-gallon water containers routinely used by many consumers and offices for dispensing drinking water from bottled water suppliers. In the neck of this bottle is placed a water-tight stopper 702. The stopper 702 is held in place by means of the collar 703, which comes in parts and can be bolted together to hold the stopper 702 in place against the bottle neck, which is designed with a lip or flange 707 of a sufficient strength to hold the collar 703 and stopper 702 in place against the pressure of the water in the bottle. The stopper 702 has a water inlet hole 705 to which is connected the water supply to the bottle 305. The stopper 702 has an outlet hole 706 which takes the water coming out of the storage bottle to the facility plumbing, or the next bottle in line in the inventive storage apparatus. The outlet hole connects inside the bottle to an outlet pipe 704 of similar diameter, which extends downwards into the bottle interior, and whose lower end 709 is no closer to the bottom of the bottle 710 than one pipe diameter. In other embodiments, the inlet and outlet can be reversed with the water entering the bottle 701 through the outlet pipe 704.

The embodiment depicted in FIG. 19 and described above approximates the flow characteristics of other embodiments described in this application, without quite matching the other embodiments' performance in eliminating eddies and stagnant water. In some embodiments, the lower end 709 of the outlet pipe 704 can be turned 90 degrees, and aligned flush with the side wall of the bottle 701 to create a swirling action which ensures that water cannot be stagnant in any part of the bottle 701. In some embodiments, the shape of the bottle 701 can be further streamlined near the lower end 709 of the outlet pipe 704 to ensure smooth flow between inlet 305 and the lower end 709 of the outlet pipe 704, eliminating any eddies or stagnant water in the bottle embodiment depicted in FIG. 19. In some embodiments, the inlet 705 can be split into multiple holes of a smaller diameter, and arranged concentrically around the stopper's central axis, with the outlet 706 moving to middle so its central axis coincides with the axis of the stopper 702.

The embodiment depicted in FIG. 19 can be scaled up with pipe diameters no smaller in diameter than the standard water supply pipe from the municipal source, in which case it is suitable to be placed in-line with the entire facility's water supply. In some embodiments, the volume of the water container can be scaled up to store enough water to support the entire household. In an alternative embodiment, the bottle of FIG. 19 can be scaled down to fit the water supply to a smaller sub-system in a facility, for instance in the supply to a single device such as a kitchen or bathroom sink, or a clothes washing machine. Apartment dwellers or the renters of small office spaces would find it difficult to make bigger changes to the water supply pipes of the facility, but can easily accommodate a bottle apparatus of the inventive system of a smaller scale, to hold 2-10 gallons of water.

The present disclosure, in various embodiments, includes components, methods, processes, systems and/or apparatus substantially as depicted and described herein, including various embodiments, subcombinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation. Rather, as the following claims reflect, inventive aspects lie in less than all features of any single foregoing disclosed embodiment.

What is claimed is:

1. An apparatus for storing water comprising:
an inlet for providing potable water;
an outlet for transmitting the potable water;
a first water storage container for storing the potable water, the first water storage container coupled between the inlet and the outlet;
a bypass pipe for diverting water around the first water storage container from the inlet to the outlet; and
a flow controller coupled to the inlet, the potable water storage container and the bypass pipe;
the flow controller having a first position providing a first flow path from the inlet through the first water storage container to the outlet and a second position providing a second flow path from the inlet through the bypass pipe to the outlet.

2. The apparatus of claim 1 further comprising:
a check valve coupled between the inlet and the first storage container for preventing the water from flowing in a reverse direction from the first water storage container to the inlet.

3. The apparatus of claim 1 wherein the first water storage container includes an inlet side and an outlet side and a first internal conical surface adjacent to the outlet side.

4. The apparatus of claim 1 further comprising:
an air vent coupled between the first storage container and the outlet for preventing air from flowing to the outlet.

5. The apparatus of claim 1 wherein the first water storage container includes a water storage pipe that is bent into a helical coil.

6. The apparatus of claim 5 wherein a portion of the helical coil is concentric to a second portion of the helical coil.

7. The apparatus of claim 1 wherein the first water storage container includes a water storage pipe that has a rectangular cross section.

8. The apparatus of claim 1 wherein the first water storage container includes a bottle, a stopper secured in a neck portion of the bottle, an inlet that passes through the stopper, an outlet that passes through the stopper and a tube coupled to the inlet or the outlet that extend to a bottom portion of the bottle.

9. The apparatus of claim 1 further comprising:
a first releasable connector coupled between the inlet and the first water storage container;
a first shut off valve coupled between the first releasable connector and the first water storage container; and
a second releasable connector coupled between the outlet and the first water storage container.

10. The apparatus of claim 9 further comprising:
a second water storage container;
a second shut off valve coupled between the second releasable connector and the second water storage container; and
a third releasable connector coupled between the water outlet and an outlet of the second water storage container.

11. The apparatus of claim 9 wherein the second water storage container is directly above the first water storage container

12. The apparatus of claim 1 wherein the flow controller includes a first valve coupled between the inlet and the first water storage container and a second valve coupled between the inlet and the bypass valve and the first position includes opening the first valve and closing the second valve and the second position includes closing the first valve and opening the second valve.

13. The apparatus of claim 1 further comprising:
a compressed gas supply for providing pressurized gas to an inlet side of the first water bottle to help expel stored water out an outlet side of the first water bottle.

14. An apparatus for storing water comprising:
an inlet for providing potable water;
an outlet for transmitting the potable water;
a first module having a first plurality of water storage containers for storing potable water from the water source, the first module coupled between the inlet and the outlet;
a bypass pipe for diverting water around the first water storage container from the water inlet to the water outlet; and
a water flow control valve coupled to the water inlet, the first module and the bypass pipe; the water flow control valve having a first position providing a first water flow path from the water inlet to an inlet of the first module and a second position providing a second water flow path from the water inlet to the bypass pipe.

15. The apparatus of claim 14 further comprising:
a check valve coupled between the inlet and the first module for preventing the water from flowing in a reverse direction from the first module to the inlet.

16. The apparatus of claim 14 further comprising:
an air vent coupled between the first module and the outlet for preventing air from flowing to the outlet.

17. The apparatus of claim 14 wherein the first water storage container includes an inlet side and an outlet side and a first internal conical surface adjacent to the outlet side.

18. The apparatus of claim 14 wherein the first plurality of water storage containers include a water storage pipe that is bent into a helical coil.

19. The apparatus of claim 18 wherein a portion of the helical coil is concentric to a second portion of the helical coil.

20. The apparatus of claim 14 wherein the first plurality of water storage containers include a water storage pipe that has a rectangular cross section.

21. The apparatus of claim 14 wherein the first plurality of water storage containers each includes a bottle, a stopper secured in a neck portion of the bottle, an inlet that passes through the stopper, an outlet that passes through the stopper and a tube coupled to the inlet or the outlet that extend to a bottom portion of the bottle.

22. The apparatus of claim 14 further comprising:
a first plurality of releasable connectors coupled between each of the first plurality of water storage containers; and
a first plurality of shut off valves coupled between each of the first plurality of water storage containers.

23. The apparatus of claim 22 further comprising:
a second module having a second plurality of water storage containers;
a second shut off valve coupled between the second releasable connector and the second water storage container; and
a third releasable connector coupled between the water outlet and an outlet of the second water storage container.

24. The apparatus of claim 22 wherein the first plurality of water storage container in the first module includes a first water storage container positioned below a second water storage container.

25. The apparatus of claim 14 wherein the flow controller includes a first valve coupled between the inlet and the first water storage container and a second valve coupled between the inlet and the bypass valve and the first position includes opening the first valve and closing the second valve and the second position includes closing the first valve and opening the second valve.

26. The apparatus of claim 14 further comprising:
a compressed gas supply for providing pressurized gas to an inlet side of the first module to help expel stored water out an outlet side of the first module.

27. A method for providing an emergency supply of water comprising:
providing a first water storage container for storing the potable water, the first water storage container coupled between a municipal water supply and water fixtures in a building;
providing a bypass pipe coupled between a municipal water supply and water fixtures in a building;
providing a flow controller coupled between the municipal water supply and the first water storage container, the flow controller having a first position providing a first flow path from the inlet through the first water storage container to the outlet and a second position providing a second flow path from the inlet through the bypass pipe to the water fixtures;
transmitting the water from the municipal water supply through the first flow path of the flow controller in the first position to the first water storage container and the water fixtures;
switching the flow controller to the second position to stop the water from flowing from the municipal water supply to the first water storage container; and
removing the water stored in the first water storage container for occupants of the building.
